(19) United States
(12) Patent Application Publication
(10) Pub. No.: US 2026/0296449 A1
(43) Pub. Date: Oct. 1, 2026

(54) AIR RESISTANCE REDUCTION DEVICE AND METHOD

(71) Applicant: Intel Corporation, Santa Clara, CA (US)

(72) Inventors: Cornelius BUERKLE, Karlsruhe (DE); Fabian OBORIL, Karlsruhe (DE)

(21) Appl. No.: 19/091,927

(22) Filed: Mar. 27, 2025

(51) Int. Cl. B60W 40/10; B60W 60/00; G07C 5/02

(52) U.S. Cl. CPC B60W 40/1005; B60W 60/001; G07C 5/02; B60W 2420/403; B60W 2420/408; B60W 2530/16; B60W 2552/15; B60W 2554/4042; B60W 2555/20; B60W 2556/40

(57) ABSTRACT

A device, including a first sensor, is configured to detect first data representing an energy usage of a first vehicle; and a processor is configured to determine, using the first data, energy used by the first vehicle for propulsion; estimate from the energy used by the first vehicle for propulsion a first air pressure, wherein the first air pressure is an air pressure at a first region, and wherein the first region is a region at a front of the first vehicle.

### BACKGROUND

Motor vehicles are subject to multiple demands that require increasing energy efficiency. A vehicle's energy consumption may be primarily understood relative to three categories: (1) the demand created by in-vehicle systems such as air conditioning, infotainment, or functions for automated driving or driver assistance; (2) the energy required to overcome the rolling resistance (e.g., friction); and (3) the air resistance or drag (e.g., the resistance imparted on a vehicle by virtue of the air that it is traveling through). As a vehicle's velocity increases, the air resistance increases quadratically and thus may play a large role in energy efficiency at higher velocities. Much engineering effort is dedicated to reducing air resistance (which may also be referred to herein as the drag coefficient, or simply drag). Such reduction of air resistance may be particularly important for electric vehicles (EVs) due to their limited range and their longer recharging breaks. For instance, a representative EV travelling at 130 km/h may require nearly 50% of its overall power to overcome air resistance. Even at 80 km/h, 20% of the vehicle's power may be required to overcome air resistance.

One way to reduce air resistance is to enhance the vehicles' aerodynamics through design. The possibilities for this are, however, limited, and so much advancement in this area has already been achieved, that little room for improvement remains available.

Another option for reducing air resistance is to optimize the driving style at runtime, i.e. to exploit the use of low pressure areas relative to other vehicles on the roadway, which may otherwise be known as “drafting”. That is, in some circumstances, air resistance can be reduced by driving behind another vehicle. Although the magnitude of air resistance reduction depends on various factors, the corresponding power savings may be quite significant and can even correspond to an approximately 90% overall savings in power consumption. Several problems with this use of drafting remain, however, such as how to ensure safe distances from nearby vehicles and how to determine a preferred location relative to another vehicle for reduced wind resistance, since the best effect is not always achieved right behind a leading vehicle, but sometimes further to the left or to the right of a vehicle.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles. In the following, various exemplary embodiments are described with reference to the following drawings, in which: FIG. 1 depicts the power consumption of an exemplary electric vehicle relative to velocity;

FIG. 2 depicts an exemplary drafting effect in which a primary vehicle trails a secondary vehicle;

FIG. 3 depicts a simulation of air velocity behind different vehicles;

FIG. 4 depicts the power required to operate a vehicle relative to velocity based on headwind;

FIG. 5 depicts a high-level overview of a vehicle device;

FIG. 6 depicts the internal measurement system of FIG. 5 in greater detail;

FIG. 7 depicts a representation of the vehicle environment annotated with any of air resistance, air pressure, or air speed;

FIG. 8 depicts a visual representation of a calculation of an expected wind speed;

FIG. 9 depicts an estimation of a wind velocity;

FIG. 10 depicts the estimated wind velocities relative to roadway sections;

FIG. 11 depicts additional segments of roadway relative to air pressure;

FIG. 12 depicts a vehicle, a danger zone at the rear of the vehicle, and safety margins;

FIG. 13 depicts the vehicle of FIG. 12 with consideration of wind direction;

FIG. 14 depicts the vehicle of FIG. 12 with consideration of passing (e.g. overtaking) a nearby vehicle; and

FIG. 15 depicts a device according to various aspects.

### DESCRIPTION

The following detailed description refers to the accompanying drawings that show, by way of illustration, exemplary details and embodiments in which aspects of the present description may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted. The phrase “at least one” and “one or more” may be understood to include a

numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the Examples expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the Examples, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A device or system (e.g., a driver assistance device or driver assistance system) may allow a vehicle to determine areas of lower air resistance based on information about the vehicle's environment, such as information about other vehicles on the road, and considering other factors such as any of wind, temperature, infrastructure, map data, etc. Using such information, the system or device can determine preferred positions on the road and/or preferred distances from other vehicles to reduce energy consumption, such as by minimizing drag. This information may be given to the driver, such as in a visualization available to the driver, or may be directly used by an autonomous driving system or an advanced driver assistance system to control the vehicle's movement.

It is expressly noted that different regions, countries, states, and/or municipalities have different driving rules and cultures. For example, in United States of America (USA), passing on both the left and the right may be permitted where the highway includes more than two lanes. Moreover, in the USA, trucks may drive as fast as normal passenger vehicles, and trucks may have multiple trailers. This offers significant freedom to position one's vehicle in an optimal manner to improve energy efficiency. In contrast, and turning to Europe, it may be the case in a particular country that trucks may have only one trailer and must typically drive slower than regular passenger vehicles. At the same time, speeds may be higher in Europe than in the USA, which may increase the effect of drafting, even when merely following a normal passenger vehicle. Moreover, in more rural regions, the use of noise deflecting walls may be more common, which may generate a preferred location for positioning the vehicle to reduce drag. In summary, although there are differences in driving practices from country to country, it is expected that reduction in drag may be achieved in many, if not all, of these constellations of driving practices. Using the apparatuses and methods disclosed herein, it is expected that at least a 10% reduction of vehicle energy consumption can be obtained, with the prospect of even greater energy reductions still. This, in turn, may significantly improve the operating range of electric vehicles.

The effects of vehicle aerodynamics, drag, and drafting have been widely studied. For example, FIG. 1 depicts the power consumption of an exemplary electric vehicle relative to velocity. Specifically, 102 depicts air resistance relative to velocity, 104 depicts energy for tire rotation relative to velocity, and 106 depicts overall energy required for vehicle operation relative to velocity. Of note, other energy (not depicted, but otherwise considered in the overall energy consumption 106 category), such as infotainment or other in-cabin services, may also play a role. As can be seen, whereas overcoming air resistance (being a quadratically-increasing factor) may consume approximately 18% of the vehicle's overall power at 80 km/h, overcoming air resistance may consume approximately 50% of the vehicle's total energy at 130 km/h. Otherwise stated, as velocity increases, the relative proportion of energy required to overcome air resistance, as opposed to the proportion of energy required for other purposes, increases and plays an increasingly greater role in the vehicle's overall energy consumption.

In some motor vehicle sports, for example, it is known to operate a first vehicle immediately behind (e.g., with little to no space between the vehicles) a second vehicle to reduce drag. That is, an area of low pressure exists immediately behind the second vehicle, and the first vehicle operating immediately behind the second vehicle enjoys reduced air resistance, and thus increased efficiency, by virtue of travelling in this area. Although this may be commonplace in a sporting environment, its implementation on the public roadways would greatly increase the risk of a collision without a parallel implementation of complex platooning and vehicle-to-vehicle communication procedures that are largely still in development and are otherwise not widely in place. Importantly, however, decreased air pressure, and therefore the benefits of the drafting effects described above, may be available to a first vehicle even at somewhat larger distances from a second vehicle. Moreover, other factors, such as wind intensity, wind direction, and other obstacles and infrastructure, may shift the most advantageous area for drafting (e.g., an area sufficiently away from the first vehicle such that safety can be maintained, while still enjoying a drafting effect) may, in some circumstances, not be directly behind the second vehicle, but may instead be to the side of the second vehicle, or in another location.

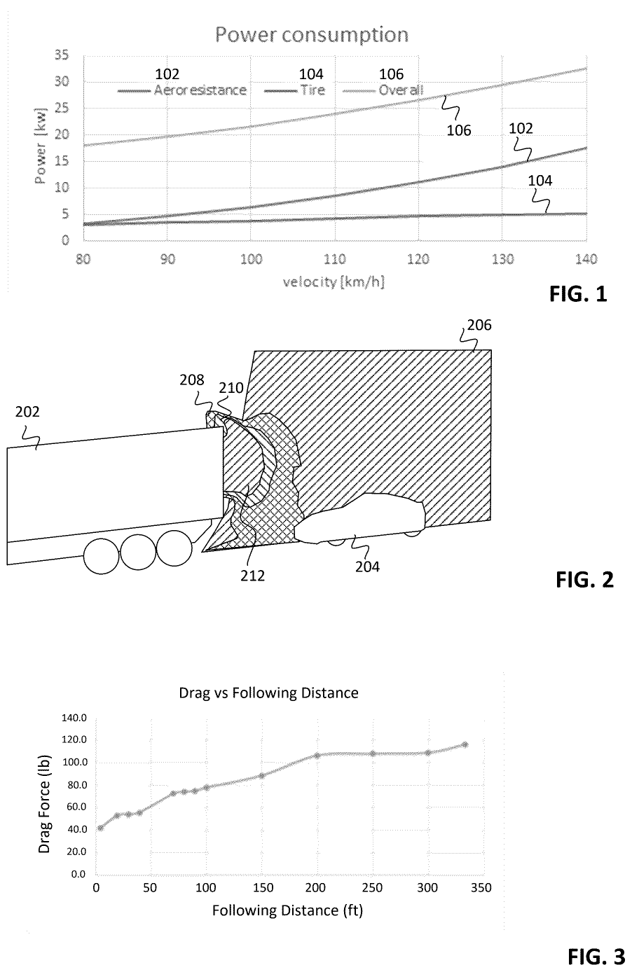

FIG. 2 depicts an exemplary drafting effect in which a primary vehicle 204 trails a (larger) secondary vehicle 202. In this figure, an area of air pressure 206 (e.g., an ambient or general air pressure) is shown in an immediate vicinity of the secondary vehicle 202. A first area of reduced air pressure 208, indicating less pressure than the first area of air pressure 206, is depicted generally between the primary vehicle 204 and the secondary vehicle 202. A second area of reduced air pressure 210, indicating less pressure than the first area of reduced air pressure 208, is depicted as an area behind the secondary vehicle 202. A third area of reduced air pressure 212, indicating less pressure than the second area of reduced air pressure 210, is a smaller area extending immediately behind the secondary vehicle 202. As can be seen in this figure, areas of reduced air pressure extend behind the secondary vehicle 202, wherein the magnitude of reduction of the air pressure changes depending on the distance from the secondary vehicle 202 and physical relationships arising out of the shape and/or mechanics of the secondary vehicle 202. In this image, the primary vehicle 204 is operating at the first area of reduced air pressure 208, which permits the primary vehicle 204 to enjoy reduced drag while still maintaining a safe distance from the secondary vehicle 202. Of note, where the primary vehicle 204 is smaller and/or shorter than the secondary vehicle 202, an area of reduced air pressure (e.g., the second area of reduced air pressure 208) may extend some distance behind the secondary vehicle 202, such that the primary vehicle could travel at least partially within this area of reduced air pressure. This may be especially true if the secondary vehicle 202 is bigger than the primary vehicle 204, such as depicted in FIG. 02. Even at 300 feet (~91,44 m), a reduction of drag can be seen.

FIG. 3 depicts a simulation of air velocity behind different vehicles. As a general matter, air pressure may be at its lowest point immediately behind a secondary vehicle and generally increases (generally in a nonlinear fashion) as the distance between the primary vehicle and the secondary vehicle increases. As can be inferred from this figure, approximately 45 m behind a truck traveling at 85 km/h, the air pressure is still significantly reduced (e.g., the air velocity may be ~70 km/h (−15 km/h)). For a smaller vehicle, for example a Sprinter (e.g., a small van), travelling at 120 km/h, at a safety distance of 60m, air velocity is reduced to 80 km/h (−40 km/h). Thus, the use of drafting, in which the primary vehicle operates immediately behind a secondary vehicle, so as to reduce air resistance, can result in meaningful efficiency gains. Since air resistance increases quadratically with speed, the energy (e.g., fuel) that can be saved by drafting a vehicle at a safe distance is considerable and can easily reach 10-20%. Or in other words, by exploiting drafting in a smart manner, the range of an EV can be extended by more than 10% under good conditions.

That is, drafting may have a strong effect on power savings and is believed to be capable of reaching power reductions of up to 90%. When cars draft, the leading car blocks the movement of air, creating low pressure behind it. The low-pressure air creates a vacuum, which essentially tugs the trailing car (e.g., primary vehicle, the first vehicle as described herein) forward while reducing the leading car's (the secondary vehicle, the second vehicle, as used herein) drag.

This can be seen, for examiner, in FIG. 3, which shows that a reduction of distance between the primary vehicle and the secondary vehicle from 340 ft to 300 ft results in a reduction of drag force of 10 lbf. This equates to a reduction of approximate 1.5 kwh, while still allowing for a safety distance about 300 ft [100m], which is far beyond the required distance to maintain safety. If the same delta velocity of the vehicles and the wind is assumed, but with a headwind of 20 km/h, this would mean that the actual driving speed is 110 km/h. In Germany, the required safety distance would be about 55 meters. At this distance, the savings would be approximately 3.7 kwh, which equates to approximately 15% of the overall power consumption.

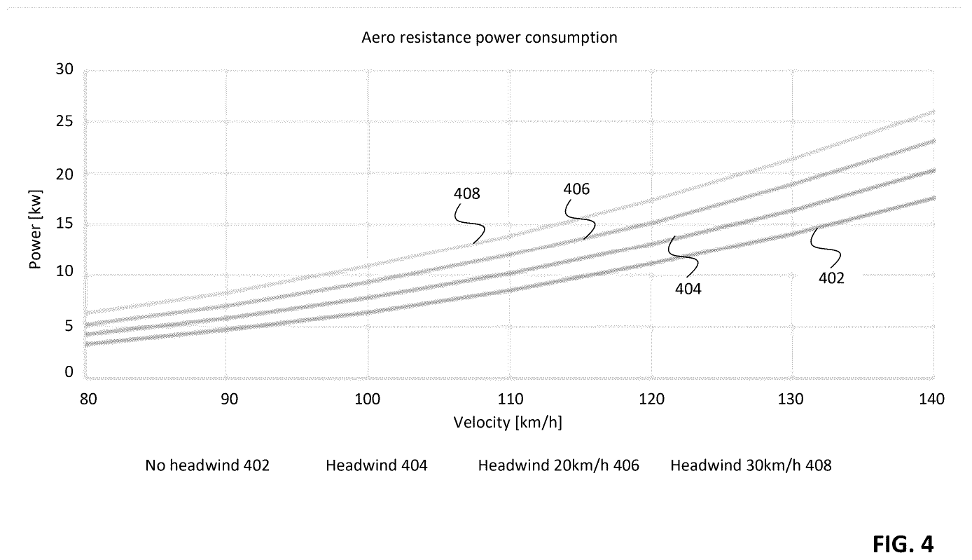

An additional aspect is that the air resistance is also affected by wind. As an example, the average wind in Düsseldorf, Germany, is 4 m/s [~15 km/h], but there are many days where much higher wind is present. On these days, the drafting effect will further increase the energy savings when following a vehicle in a headwind. This may be seen in greater detail in FIG. 4, which depicts the power required to operate a vehicle relative to velocity based on headwind. In this figure, the power required to operate a vehicle relative to velocity in no headwind is depicted as 402; the power required to operate a vehicle relative to velocity in a headwind of 10 km/h is depicted as 404; the power required to operate a vehicle relative to velocity in a headwind of 20 km/h is depicted as 406; and power required to operate a vehicle relative to velocity and headwind of 30 km an hour is depicted as 408. From this figure, it can be seen that, for the exemplary vehicle, traveling at a velocity of 80 km/h, 10 km/h of headwind results in an increased power consumption of 1 kw. With an overall consumption of 18 kw, removing the headwind represents a power reduction of about 5%. With headwind of 30 km/h, however, the power consumption increases by 3 kw and would therefore constitute a power reduction of about 15%. At 120 km/h, a headwind of 10 km/h adds 2 kw, and a headwind of 30 km/h requires an additional 6 kw of power. Overall power consumption at that speed is about 26.5 kw, and therefore removing or reducing the headwind by drafting may save about 7% to about 20%, depending on the circumstance.

As stated above, much engineering effort has already been invested in reducing the air resistance of a vehicle at design time. Thereafter, e.g., at runtime, when the vehicle is operated on a road, there are limited solutions to improve energy efficiency other than by changing the driving style. For example, some vehicles operate at lower ride heights, which reduces drag at higher speeds. Also, platooning could theoretically be used to reduce drag by configuring two or more vehicles to follow one another in close proximity; however this not widely implemented and remains more of theoretical idea than a practical solution. In other words, there is no known driver assistance system that can calculate an optimal vehicle position given its surroundings to maximize energy efficiency.

Herein is described an (automated) driver assistance or automated driving system that may detect information related to a vehicle's environment (e.g., as wind speed, surrounding vehicles or other objects) to determine the locations of low pressure areas that the vehicle can exploit by drafting. That is, one the locations of these areas are determined, the system may determine a preferred position of the vehicle, given its desired speed and the behavior of the surrounding vehicles, while always respecting safety distances. Final position information corresponding to these low-pressure areas may then be provided to the driver (e.g., though an in-vehicle entertainment system) or used directly by an AD/ADAS component to control the vehicle. The expected savings can be larger than 10% for highway-like velocities. Advantages of this approach are manifold. As a general principle, drivers will generally appreciate any system that enables a more efficient driving experience. That is, whether an EV or combustion engine vehicle, greater efficiency translates to cheaper driving, which will be valued.

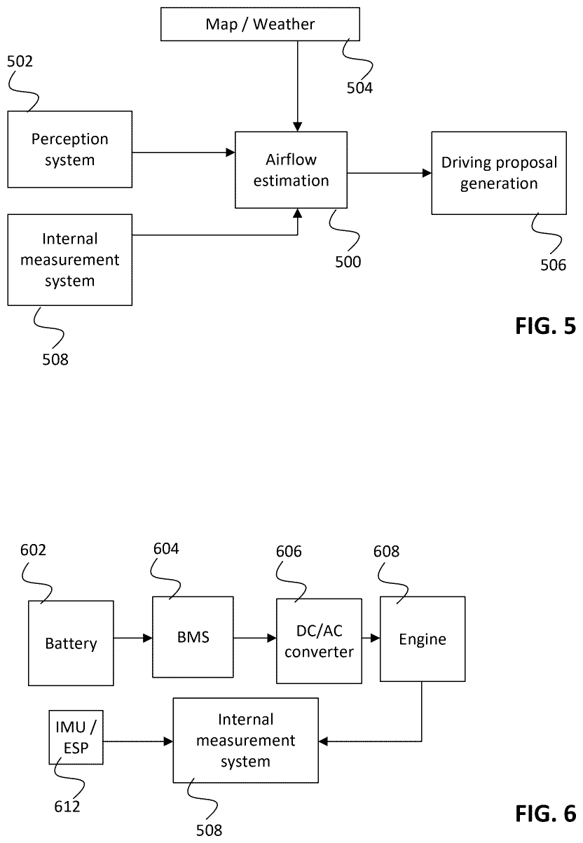

FIG. 5 depicts a high-level, functional overview of the vehicle system disclosed herein. As can be inferred, the system may use data from the vehicle's perception system 502, map and weather data 504, and information from an internal measurement system 508 as input. Based on those data, it estimates the airflow (airflow estimation 500) in the vehicle environment to finally derive a driving proposal 506 containing the optimal vehicle position to improve energy efficiency while respecting safety. In the following, each component is discussed in detail.

The perception system 502 may provide information about the environment of the vehicle. Many vehicles currently include perception systems, and it is generally intended that existing perception systems may be configurable to perform the actions of the device, system, and methods disclosed herein. In this manner, no additional sensors or processing units beyond those already included in vehicle perception systems are necessary. The information gathered by the perception system may include any of the position, dimension, or velocities of vehicles in the surroundings (e.g., near, close to) the primary vehicle. The perception system may optionally provide information about infrastructure or other three-dimensional structures, such as buildings, trees, walls, or topological data (e.g. hills).

Although existing perception systems may be useable for the aims described herein, such perception systems alone may not provide all data necessary to assess air pressure or air resistance (e.g., drag), such as wind direction, roadside elements, or a shape or configuration of a road ahead. In this manner, the device disclosed herein may include one or more connections to a map service and/or a weather data 504 (e.g., data from a weather service). The map service, for example, may offer a high-definition map of the primary vehicle's surroundings, such as maps that are otherwise used to for automated driving, or it may offer comparatively simple maps, such as those available through OpenStreetMap, and which provide information about the road parameters ahead (e.g. number of lanes, roadside elements such as trees, or walls, whether the road is on an incline or a decline, etc.). The weather service may provide fundamental data on wind direction and speed.

The internal measurement system 508 may aggregate information about the current state of the vehicle itself, such as to estimate the current air speed in front of the vehicle. Details of the internal measurement system 508 may be set forth below. The airflow estimation 500 may take place based on the internal measurement system 508, the perception system 502, and optionally the map or weather data 504. Based on the airflow estimation 500, a driving proposal 506 is created. That is, based on the airflow estimation 500 in which one or more areas of reduced air pressure compared to the current air pressure for the primary vehicle are determined, a driving proposal to move to an area of the one or more areas of reduced air pressure is generated.

FIG. 6 depicts the internal measurement system 508 in greater detail. The internal measurement system 508 may aggregate information about the current state of the vehicle itself, such as to estimate the current air speed in front of the vehicle. The internal measurement system 508 may collect data from any of vehicle sensors, the battery 602, the battery management system (BMS) 604, a DC/AC converter 606, the engine 608, or the Inertial Measurement Unit/Electronic Stability Program 612. Such collected information may be or include basic air resistance information such as any of surface area dimensions and drag coefficient (which may be known from the vehicle design); vehicle weight and tire pressure (for both active sensors exist already and only need to be installed in the vehicle); or vehicle dynamic data such as velocity and power consumption provided by the vehicle's sensors and engine controllers. In this regard, the power/energy provided to the wheels (e.g., propelling energy) may be of particular interest, as it may exclude the demand created by in-vehicle or AD/ADAS features. Data regarding vehicle orientation may be used to estimate road incline (uphill/downhill). GPS and temperature sensor data may be used to obtain the current ambient temperature and the height above sea level.

To estimate the air velocity in front of the vehicle, which is needed to determine the best vehicle position, either of two approaches may be used. The first approach requires the use of pressure sensors, which may not otherwise be present in a vehicle and may thus result in additional cost to implement, but which offer the benefit of estimating pressure at multiple locations, which can permit the vehicle to determine both head wind and side wind. That is, if such pressure sensors can be installed, they may be installed at an desired location on the vehicle, and they may be used to determine the air pressure at those locations. It is envisioned, for example, that such sensors, if used, could be installed at the front of the vehicle and on each of the left and right sides of the vehicle.

Should it be undesirable or impracticable to use such pressure sensors, the second approach is to estimate the frontal air speed by correlating the force to overcome the air resistance with the speed:

$${F}_{drag} = 0.5 * p * {( {v}_{car} + {v}_{air} )}^{2} * {C}_{g} * A \qquad ( 1 )$$

This can be rewritten and expressed as:

$${v}_{air} = \sqrt{\frac{{F}_{drag}}{0.5 * p * A * {C}_{g}}} - {v}_{car} \qquad ( 2 )$$

By further knowing that

$${F}_{drag} = \frac{{P}_{air}}{{v}_{car}} \qquad ( 3 )$$

the air speed can be obtained by:

$${v}_{air} = \sqrt{\frac{{P}_{air}}{0.5 * {v}_{car} * p * A * {C}_{g}}} - {v}_{car} \qquad ( 4 )$$

The vehicle speed car is already known in each vehicle and can be obtained from the system that determines the speed and/or displays the speedometer. The frontal vehicle surface A is also known, as it is a value that is essentially fixed at the time of manufacture and is thus also known. The vehicle's drag coefficient C_{g} and the air density p can be calculated based on height and outside temperature. Thus, the only unknown for the above equations is the power required to overcome the air resistance Pair. This can be estimated using the total power output P_{engine} obtained through vehicle's sensors, and an estimation of power to overcome rolling resistance Pₜᵢᵣₑ (through tire pressure and temperature) and the power required for elevation changes Pₑₗₑᵥₐₜᵢₒₙ.

$${P}_{air} = {P}_{engine} - {P}_{elevation} - {P}_{fire} \qquad ( 5 )$$

The airflow estimation 500 may create a representation of the vehicle environment annotated with any of air resistance, air pressure, or air speed. The representation can be continuous, such as with potential fields, or may use a grid-like representation as illustrated in FIG. 7. In this figure, a roadway is depicted as being including four segments (702, 704, 706, and 708), which correspond to air resistance (e.g., arising from air pressure) based on wind. In this exemplary configuration, one side of the roadways includes a barrier of trees or other barriers (e.g., the circles at the bottom of the figure, in which a sample tree or barrier is identified as 710), and two vehicles, 712 and 714 respectively, as operating on the roadway. Since the trees or barriers 710 block or otherwise hinder the wind, they affect the resulting areas of pressure on the roadway. Assuming a wind direction in accordance with the black arrow, the roadway may be represented by four fields. In this manner, segment 706 may be depicted (e.g., with a color, with a pattern, etc.) as representing an area of the lowest air pressure (e.g., the lowest air resistance); segments 704 and 708 may be depicted as representing areas of moderate air pressure; and segment 702 may be depicted as representing an area of the lowest air pressure.

As illustrated and explained above, the air resistance depends on the environment and basic wind data. Therefore, the data from the perception system, the map data, and the weather data, as well as the estimated air speed (or air resistance) may be used as input for this component.

The first step before the actual air resistance map (or air flow estimation) can be calculated is to generalize the input data. While the system receives the current (frontal) air velocity from the internal measurement system, this data may be affected by environmental conditions, which may not reflect the current situation. For example, this data may be influenced by slipstreams of structures in the nearby environment and/or other traffic participants.

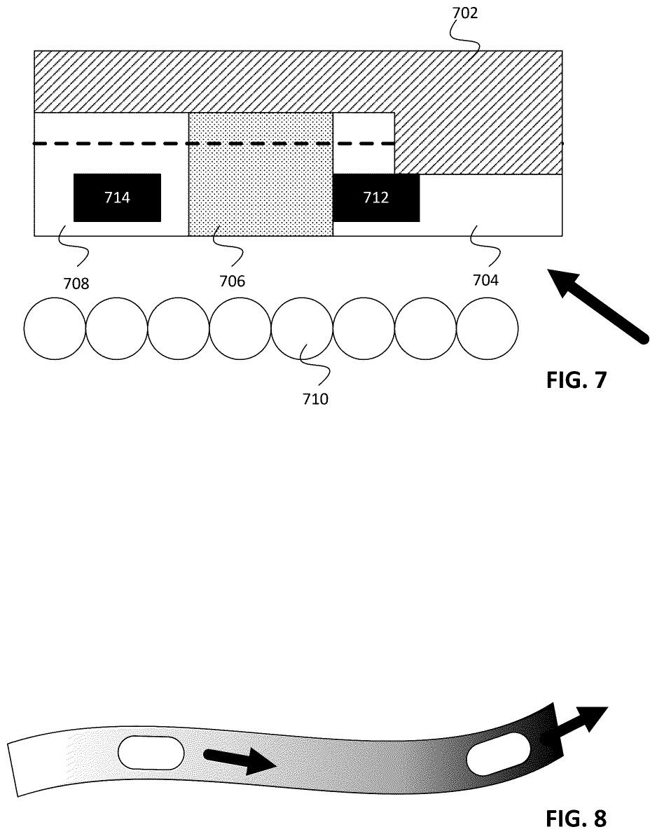

To counteract this, an iterative process may be used to convert the received air velocity into a representation of the actual wind speed. Given an a priori estimation of the air velocity, the environment model from the perception system may be used to determine the expected wind velocity for the current position. FIG. 8 depicts a visual representation of a calculation of an expected wind speed, in which expected wind speed is determined (e.g., based on wind speed measurements or estimations from other vehicles, roadside infrastructure, or other sources). Values corresponding to areas between measurements may be interpolated, as evidenced by the gradient change in color, which represents wind speed. As such, the expected wind velocity reduction caused by other traffic participants may be calculated. Moreover, other environmental structures, such as walls or trees, may be considered. The error of the measured wind velocity may then be collected and used to adjust the a priori wind estimation for the next iteration.

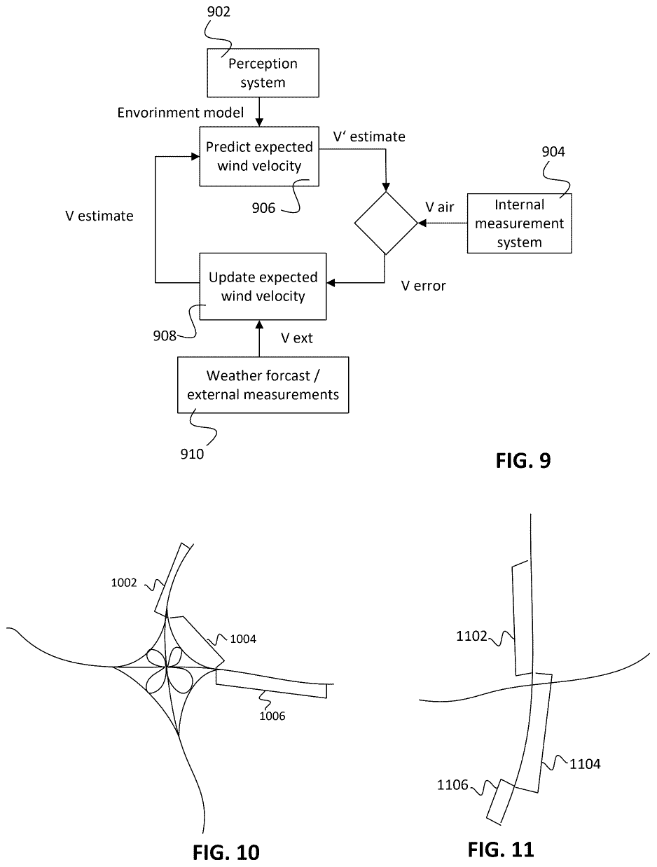

FIG. 9 depicts an estimation of a wind velocity, according to an. In this figure, the perception system 902 may provide its data into an environment model 906, which may be configured to predict expected wind velocity. A predicted wind velocity may then be compared to a measured value, such as from the internal measurement system 904, and error (the difference between the estimated velocity and the measured velocity) may be delivered to a model that may be configured to update the expected wind velocity 908. Based on the updated expected wind velocity, a subsequent wind velocity is predicted at 906. In this manner, the prediction of when velocity becomes an iterative process, which may yield increased overall accuracy. During this process, and in particular during the update of the expected wind velocity at 908, the model may include/consider one or more weather forecasts and/or external measurements 910.

In one aspect, the determined wind velocity may be depicted at a more macroscopic level, as shown by FIGS. 10 and 11. In FIG. 10, the estimated wind velocities are depicted as corresponding to three segments of roadway, such that a first roadway segment 1002 corresponds to light wind, a second roadway segment 1004 corresponds to medium wind, and a third roadway segment 1006 corresponds to high wind. Similarly, FIG. 11 depicts additional segments of roadway in which 1102 represents a segment of roadway having low wind (low air pressure), 1104 represents a roadway segment having medium wind, and 1106 represents a roadway segment having high wind. By combining the wind information with map data, the effect of wind to the power consumption can be anticipated.

With that, regions with high or low wind speeds can be determined. This can be used to optimize power consumption even further. For example, in regions of strong headwinds, it might be advisable to stay behind a leading vehicle. Moreover, passing (e.g., overtaking) maneuvers may be timed for situations where fewer headwinds are expected, such as when approaching a wind-wall, a forest, or curves that change the route direction.

Once the corrected wind speed and direction is obtained, the actual prediction of the air resistance/velocity can be performed with a variety of approaches. These may include the corrected wind data, map information, and the environment model from the perception system.

One possibility is to use all of the input data to run a kind of computational fluid dynamics simulation, such as by using OpenFOAM. This, however, requires significant computational resources to provide realtime information that can be used to generate adequate driving decisions. In some circumstances, it may be acceptable to provide some general guidance to a driver, such as, for example, to stay closer to a wall on the right roadside.

An alternative solution is to train an AI model to generate such an air resistance map. Both the current state and some history of states may be needed to provide good estimations. Therefore, a long short-term memory (LSTM) network that captures the dependency to past states may be particularly well-suited for this task. LSTMs have successfully predicted the behavior of traffic participants and can be extended or similarly utilized to generate air resistance maps. It may be advantageous to use physics-driven models that allow for the capturing of physical relations such as wind shadow regions next to walls or trees, wind deflection, or turbulent areas near approaching traffic, etc.

Moreover, transformer networks that can handle time series data can be used for this purpose. For example, Spacetimeformer, which is a transformer that combines or utilizes both temporal attention method and spatial attention methods, may be particularly well-suited. Such models allow both a temporal as well as spatial embedding to capture the past wind information, air resistance maps, and movement of vehicles. The object position information can be provided as input images to one or more LSTMs or transformer networks; wind data can either be encoded as image, or, for a transformer network, provided as additional text input, e.g using a vision-language model (VLM).

The model to estimate the air resistance map should ideally not only provide an estimation of the current point in time, but ideally also provide some prediction about the near future. This aids in understanding of whether a zone of reduced air speed will disappear soon, for example resulting from an approaching road turn or because a vehicle will finish an overtaking maneuver. Hence some traffic behavior prediction may be involved in this process, which is another reason why LSTM models are good candidates for this process.

With the output from the previous component, i.e. the air resistance map, a driving proposal is generated. This proposal can then be visualized to inform the driver about a better vehicle position or can be used as input to an ADAS/AD component to reposition the vehicle.

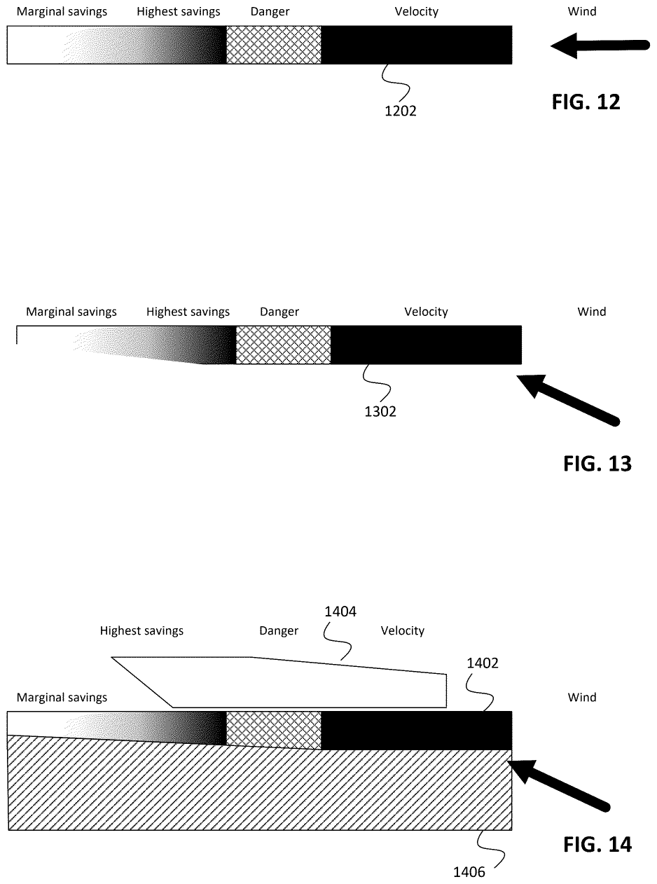

The first step is to take the vehicles' velocity and estimate the required safety distances. All regions that are closer to other objects than these safety margins are marked as no-go zones, as illustrated in FIGS. 12 and 13. For example, FIG. 12 depicts a vehicle at 1202, followed by a danger zone, in which, despite the air resistance being low, the corresponding region is too close to the secondary vehicle for a primary vehicle to maintain a sufficient safety margin. This is followed by a region of highest savings (e.g. a region of lowest air pressure at a minimum acceptable safety distance from the secondary vehicle), followed by a region of marginal savings. Of note, the wind direction in FIG. 12 is represented by the horizontal arrow pointing left. FIG. 13 depicts the same situation as in FIG. 12, except that the wind direction (also indicated by the arrow) has changed directions. As with FIG. 12, the primary vehicle 1302 is followed by a danger zone, a highest savings zone, and a marginal savings zone. Of note, because of the change in wind direction, certain portions of the beneficial zones may no longer be beneficial, as the air pressure may increase in certain portions of the zones, as indicated by the diagonal line. Of the remaining regions, those that promise the highest energy savings are selected for further evaluation.

FIG. 14 depicts a further calculation, in which the benefit of passing (e.g. overtaking) a nearby vehicle can be obtained. In this figure, the secondary vehicle 1402 is followed by a danger zone, a zone of highest savings, and the zone of marginal savings, as in FIGS. 12 and 13. In this figure, however, an additional zone 1404 of some savings relative to air resistance is depicted to the left of the secondary vehicle 1402, and in a zone 1406 of increased power consumption to the right of the secondary vehicle 1402. In this manner, a vehicle traveling in a less desirable zone, for example in the marginal savings zone or in the zone 1406 of increased power consumption, may be prompted to pass these secondary vehicle 1402.

It may happen that there are different disjunct regions that offer similar energy savings. In this case, the reachability of the regions and their implications are evaluated. For example, if there is one region to the left of a truck and a region behind the same truck are equivalent in terms of savings, the one behind the truck will be the preferred option. Furthermore, zones behind other vehicles can quickly disappear when the leading vehicles are faster or much slower than the ego vehicle. This may also considered when generating driving proposals.

Finally, the best proposal is selected and presented to the driver or forwarded to an active driving control system, such as an advanced adaptive cruise control, or other kind of autonomous or semi-autonomous driving module.

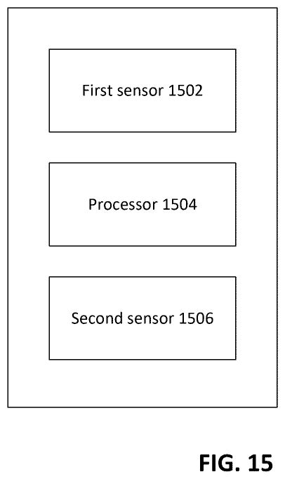

FIG. 15 depicts a device that may include a first sensor 1502, which may be configured to detect first data representing an energy usage of a vehicle. The device may further include a processor 1504, which may be configured to determine, using the first data, energy used by the vehicle for propulsion, and to estimate from the energy used by the vehicle for propulsion a first air pressure, wherein the first air pressure is an air pressure at a first region adjacent to the vehicle. The first sensor may be or include a sensor capable of determining or measuring electrical energy used by the vehicle, such as a sensor to determine or measure power, current, voltage, available battery resources, or the like. Alternatively or additionally, the first sensor may be a sensor capable or determining or measuring a torque applied to the wheels of the vehicle.

The device may further include a second sensor 1506, which may be configured to detect second data representing a vicinity of the vehicle. The second sensor 1506 may be any sensor or combinations of sensors that can determine information about an environment in which the vehicle is operating. This may be or include one or more image sensors (e.g., cameras), LiDAR sensors, or RADAR sensors that may detect one or more secondary vehicles in a vicinity of the primary vehicle, one or more infrastructure objects (e.g., walls, bridges, barriers, hills, or anything else that may block or otherwise change a pattern of airflow), or a weather condition or pattern. The processor 1504 may be further configured to estimate, using the second data, a second air pressure; and generate a signal when the second air pressure is less than the first air pressure; wherein the second air pressure is an air pressure at a second region non-adjacent to the vehicle.

The device may be configured to use the first data to estimate an air pressure at a first region, wherein the first region is adjacent to the vehicle. In this manner, the device (such as using the processor) may determine a first air pressure that is adjacent to the vehicle, which may more specifically be an area immediately in front of the vehicle, which may best correspond to the relevant air pressure for the drag on the vehicle. Otherwise stated, the device may determine an air pressure in an area in which the vehicle is traveling, and this determination may serve as a basis of comparison to an estimated air pressure in another region that is not adjacent to the vehicle.

In this manner, the device may be configured to use the second data to estimate an air pressure at a second region, wherein the second region is not adjacent to the vehicle. That is, the device may use the second data to determine or estimate an air pressure somewhere other than an area adjacent to the vehicle. In this manner, the estimated air pressure of the second region may serve as a comparison to the determined air pressure at the first region, such that a recommendation may be created for the vehicle to switch from the first region to the second region, in order to travel within an area of reduced air pressure. It is expressly noted that the first area may be an area at the front of the vehicle or directly ahead of the vehicle. That is, there is always expected to be an area of low pressure just behind the vehicle, and this particular area may be of little value in making the decisions described here. Rather, it may be desired to determine an air pressure of an area immediately in front of the vehicle and to compare this to an estimated air pressure in a vicinity of the vehicle (e.g., not necessarily adjacent to the vehicle but within an area in which the vehicle could travel).

According to one aspect, the second data may include data that indicate wind direction. In this manner, the second data may indicate a direction that the wind is travelling, which may be obtained through direct measurement, such as with a sensor on the vehicle or by obtaining such information from a roadside sensor. Alternatively or additionally, these data may be obtained from an external service, such as a weather service, in which data related to the wind are transmitted (e.g., broadcast, sent directly to the vehicle, etc.) to the vehicle. However obtained, the processor may consider the wind direction information in estimating an air pressure of a nearby area (e.g., a second region). That is, depending on the wind direction, an area adjacent to a wall may have a very high or very low air pressure, as the wind may be blocks from that area, or it may be concentrated in an area and result in increased air pressure. Similarly, and depending on the wind direction, an area in a vicinity of a secondary vehicle may have an increased or a decreased air pressure as compared to the ambient air pressure, such as described relative to FIGS. 7, 13, and 14.

According to another aspect, the second data may include data that indicate a wind velocity. It is noted that a velocity, which by definition includes both direction and magnitude, may be closely tied with the wind direction, as described above. The processor may consider the wind velocity in determining the air pressure of a second region (e.g., an area in the vicinity but not directly in front of the primary vehicle). For example, a greater velocity in an opposite direction of the path of travel of the primary vehicle is expected to increase the corresponding air pressure, and a greater velocity in the direction of the path of travel of the primary vehicle is expected to reduce the corresponding air pressure. A velocity at an angle of a vehicle (e.g., wind coming from the right of a vehicle) would be expected to generate a different air pressure on the left of the vehicle than on the right of the vehicle, etc.

The term vehicle, when used without a modifier, is generally understood herein as the first vehicle, which may otherwise be referred to as the primary vehicle or the ego vehicle, and which refers to a vehicle in which a current air pressure immediately in front of the vehicle is compared to an air pressure elsewhere. The processor estimating the first air pressure may include the processor using the first data to estimate an air pressure in the first region, and the first region may be an area in a vicinity of the first vehicle, such as immediately in front of the first vehicle.

The processor estimating a second air pressure using the second data may include the processor estimating the air pressure at a second vehicle (e.g., in front of the second vehicle, behind the second vehicle, or to the side of the second vehicle), or near an obstacle or a physical structure (e.g., a wall, a barrier, a hill, etc.).

The second data may be determined based on a second sensor, which may include a camera, a Light Detection and Ranging (LiDAR) device, a Radio Detection and Ranging (RADAR) device, or a sensor to obtain map data (e.g., a receiver, transceiver, etc.). In this manner, the processor may use any, or any combination of, the second data to estimate an air pressure of the second region. This may be combined with wind magnitude and/or wind direction.

The processor may be configured to use the second data to determine a dimension or a velocity of the second vehicle, an obstacle, or a physical structure. The processor may, for example, obtain image data, such as from a camera, a LiDAR, a RADAR, or otherwise, and may derive, using any known technique, a dimension (e.g., a size, a length, a height, a width, an area, etc.) and/or a velocity. In this manner, the processor may be configured to estimate the second air pressure using the dimension and/or the velocity.

The second region may be understood as an area in a vicinity of the second vehicle. In this manner, the processor may estimate the second air pressure based on a location of the second region relative to the second vehicle and based on a velocity or acceleration of the second vehicle. In estimating the second air pressure, the processor may consider, or use as a basis, the determined first air pressure. That is, the processor may determine the first air pressure, for example just in front of the first vehicle, and then adjust the determined first air pressure based on one or more other factors. For example, the first air pressure may be reduced for a calculation of the second air pressure if the second region is closely behind a second vehicle (e.g., if the first vehicle could operate in a low pressure area behind the second vehicle).

The device may optionally include a position sensor (e.g., a sensor configuration to determine a position, such as with the Global Positioning System network, or any other satellite positioning network), which may be configured to determine a position of the first vehicle or the second vehicle. In another optional configuration, the device may further have access to third data, which may correspond to a map of a vicinity of the first vehicle. In this configuration, the processor may be further configured to determine the first air pressure using the first data and the third data and/or the second air pressure using the second data and the third data. Should the device include a position sensor, the device may have access to fourth data, which may correspond to a weather of a vicinity of the second vehicle. In this manner, the processor is may be further configured to determine the second air pressure using the second data and the fourth data.

In an optional configuration, the vehicle may have access to fifth data, which may include one or more surface area dimensions of the first vehicle or the second vehicle. That is, the processor may take into account one or more surface area dimensions of the first vehicle in determining the air pressure at the (front of the) first vehicle. Similarly, the processor may have access to surface area dimensions of the second vehicle, such as by receiving a transmission of such dimensions, the first vehicle measuring the dimensions of the second vehicle, and/or the first vehicle determining a make and model of the second vehicle (e.g., through an analysis of camera data, LiDAR data, etc.) and looking up the dimensions in a lookup table stored in a memory. In this manner, the processor may be further configured to estimate the second air pressure using the second data and the fifth data.

In an optional configuration, the first vehicle may have access to sixth data, which may include one or more drag coefficients of the first vehicle and/or the second vehicle. In this manner, the processor may determine the first air pressure using the first data and the sixth data. Similarly, the first vehicle may obtain the sixth data from a transmission by the second vehicle or by determining a make and model of the second vehicle and looking up the make and model in a lookup table. In this manner, the processor may determine the second air pressure using the second data and the sixth data.

The processor may be further configured to estimate an incline or decline of a road and to estimate the first air pressure or the second air pressure using the estimated incline or decline. In this manner, one or more sensors (e.g., accelerometers, inclinometers, etc.) to determine an incline or a decline or a roadway. Alternatively or additionally, the incline or decline may be determined by correlating a position of the vehicle with a map that contains incline or decline information based on position. However the incline or decline is calculated, and in particular when the air pressure is measured based on an electrical output of the vehicle or a force applied to the wheels, the incline or decline may be considered. For example, a vehicle travelling up an incline will require extra power to simply account for the vertical forces necessary to account for the incline, and thus the actual air pressure would be expected to be less than might otherwise be estimated if the incline were not taken into account. Similarly, the calculated air pressure might be lower than an actual air pressure if the vehicle is on a decline and the decline were not taken into account in the air pressure measurement.

In an additional configuration, the processor may be further configured to determine an ambient air temperature in a vicinity of the first vehicle. In this manner, the processor estimating the first air pressure or the second air pressure may include the processor estimating the first air pressure or the second air pressure using the ambient air temperature. As is shown above, the ambient air temperature is related to the overall air pressure and thus can be considered in determining the air pressure. Because the first region and the second region are expected to be at least sufficiently close to one another that the vehicle can travel from the first region to the second region in a short duration, it is expected that a measured or estimated temperature of the first region can be applied to the second region.

In an optional configuration, the first data may represent energy for propulsion of the first vehicle as applied to one or more wheels of the first vehicle. In this manner, the processor may be is configured to estimate the first air pressure based on the second data and at least one of a velocity or acceleration of the vehicle.

Depending on the comparison of the first air pressure and the second air pressure, the vehicle may be configured to output a signal. For example, when the first air pressure is greater than the second air pressure, meaning that the pressure just in front of the primary vehicle is greater than the air pressure in the second region, the primary vehicle may be configured to output a signal. This signal may be, for example, an instruction to display a location of the second region to the driver. Alternatively or additionally, the second signal may be or include a recommendation to operate the vehicle in the second region. The second signal may be or include a signal for an autonomous driving system or a signal for a driver assistance system to cause the vehicle to travel from the first region to the second region. Conversely, if the first pressure (the pressure immediately ahead of the first vehicle) is less than the second pressure, the first vehicle may be configured not to send the signal. In this manner, the first vehicle would not send a signal to cause the first vehicle to travel from the first region to the second region, or to recommend that the driver operate the vehicle such that it travels from the first region to the second region. Alternatively, the signal could be understood as a first signal, and the vehicle could be configured to cause the processor to send a second signal, wherein the second signal is an instruction to stay in the first region or to stay on the current path of travel.

The device as described herein may be configured as a component of the vehicle, of a component of an autonomous driving system of the vehicle, or a component of a driver assist system of the vehicle. In this manner, the device may be part of a larger form factor.

According to another aspect, the device may further include an artificial neural network, which may be configured to perform any of determining the first air pressure, determining the second air pressure, comparing the first air pressure and the second air pressure or causing the device to send the signal. The artificial neural network may be any kind of artificial neural network, without limitation, although as described above, a long short-term memory configuration may be beneficial in certain circumstances. The artificial neural network may be trained on any training data suitable to achieve the results described herein. In one exemplary configuration, the artificial neural network may be trained with image data of a first vehicle relative to another object such as a second vehicle, an infrastructure object, an obstacle, or otherwise, along with measurements or determinations of respective air pressure. These data may further include any of wind direction, wind velocity, ambient air temperature, or otherwise. In this manner, the processor may be configured to estimate the first air pressure and the second air pressure using the artificial neural network.

The device may be optionally configured to incorporate safety into the selection of a second region. As stated above, the area immediately behind the secondary vehicle may, in some circumstances, have the least air pressure of any area around the secondary vehicle. Although operating the primary vehicle in this area (e.g., in extremely close proximity to the rear of the secondary vehicle) may be efficient from the perspective of energy use, this area may be associated with an elevated (in some circumstances, an extremely elevated) risk of collision. As such, merely considering low air pressure alone in selecting a second region in which the primary vehicle should travel may be undesirable. Accordingly, the device may be configured to select a plurality of candidate second regions based on low air pressure using any of the methods and/or criteria disclosed herein. In addition, the device may be configured to identify or determine and area of increased danger, such as the area between the secondary vehicle and a safe following distance. Note that the safe following distance may be predetermined based on any of velocity, road conditions, or local regulations. The device may then be configured to select the second region from the plurality of candidate second regions as a second region that is outside of the area of increased danger. In some configurations, this may be the candidate second region having the lowest estimated air pressure that is also outside of the area of increased danger.

Further aspects will be disclosed by way of Example:

In Example 1, a device, including: a first sensor, configured to detect first data representing an energy usage of a first vehicle; and a processor, configured to: determine, using the first data, energy used by the first vehicle for propulsion; estimate from the energy used by the first vehicle for propulsion a first air pressure, wherein the first air pressure is an air pressure at a first region, and wherein the first region is a region at a front of the first vehicle.

In Example 2, the device of Example 1, further including a second sensor, configured to detect second data representing a vicinity of the first vehicle; wherein the processor is further configured to: estimate, using the second data, a second air pressure at a second region, wherein the second region is different from the first region; and generate a signal when the second air pressure is less than the first air pressure.

In Example 3, the device of Example 1, wherein the processor estimating the second air pressure includes the processor using the second data to estimate an air pressure in the second region, wherein the second region is an area in a vicinity of a second vehicle, an obstacle, or a physical structure.

In Example 4, the device of Example 1 or 3, wherein the second sensor includes a camera or a Light Detection and Ranging (LiDAR) device, a Radio Detection and Ranging (RADAR) device, or a sensor to obtain map data.

In Example 5, the device of Example 4, wherein the processor is further configured to determine a dimension or a velocity of the second vehicle, the obstacle, or the physical structure, and wherein the processor estimating the second air pressure includes the processor estimating the second air pressure using the dimension or the velocity.

In Example 6, the device of Example 4 or 5, wherein the second region is an area in a vicinity of the second vehicle, and wherein the processor estimating the second air pressure includes the processor estimating the second air pressure based on a location of the second region relative to the second vehicle and based on a velocity or acceleration of the second vehicle.

In Example 7, the device of any one of Examples 1 to 6, further including a position sensor, configured to determine a position of the first vehicle or the second vehicle; and further including third data, corresponding to a map of a vicinity of the first vehicle or the second vehicle; and wherein the processor is further configured to determine the second air pressure using the second data and the third data.

In Example 8, the device of any one of Examples 1 to 7, further including a position sensor, configured to determine a position of the first vehicle or the second vehicle; and further including fourth data, corresponding to weather of a vicinity of the first vehicle or the second vehicle; and wherein the processor is further configured to determine the first air pressure using the first data and the fourth data, or wherein the processor is further configured to determine the second air pressure using the second data and the fourth data.

In Example 9, the device of any one of Examples 1 to 8, further including fifth data including one or more surface area dimensions of the second vehicle, and wherein the processor is further configured to determine the first air pressure using the first data and the fifth data, or wherein the processor is further configured to estimate the second air pressure using the second data and the fifth data.

In Example 10, the device of any one of Examples 1 to 9, further including sixth data including one or more drag coefficients of the first vehicle or the second vehicle, and wherein the processor is further configured to determine the first air pressure using the first data and the sixth data, or wherein the processor is further configured to estimate the second air pressure using the second data and the sixth data.

In Example 11, the device of any one of Examples 1 to 10, wherein the processor is further configured to estimate an incline or decline of a road, and wherein the processor is further configured to estimate the first air pressure or the second air pressure using the estimated incline or decline.

In Example 12, the device of any one of Examples 1 to 11, wherein the processor is further configured to determine an ambient air temperature in a vicinity of the vehicle, and wherein the processor estimating the first air pressure or the second air pressure includes the processor estimating the first air pressure or the second air pressure using the ambient air temperature.

In Example 13, the device of any one of Examples 1 to 12, wherein the first data represent energy for vehicle propulsion as applied to one or more wheels of the first vehicle, and wherein the processor is configured to estimate the first air pressure based on the first data and at least one of a velocity or acceleration of the vehicle.

In Example 14, the device of any one of Examples 1 to 13, wherein the processor is further configured to determine an area of increased danger in a vicinity of the second vehicle, and the processor is configured to define the second region such that the second region lacks the area of increased danger.

In Example 15, the device of any one of Examples 1 to 14, wherein the vehicle generating the signal includes the vehicle sending an instruction or a recommendation to a driver assistance module or an autonomous driving module for the vehicle to travel to the second region.

In Example 16, the device of any one of Examples 1 to 15, wherein the device is configured as a component of the vehicle, of a component of an autonomous driving system of the vehicle, or a component of a driver assist system of the vehicle.

In Example 17, the device of any one of Examples 1 to 16, wherein estimating the first air pressure includes estimating the first air pressure based on any of a power or force generated from an engine of the first vehicle, a change in elevation of the second vehicle, and a rolling resistance of the second vehicle.

In Example 18, the device of any one of Examples 1 to 17, further including an artificial neural network, wherein the processor is configured to estimate the first air pressure and the second air pressure using the artificial neural network.

In Example 19, a non-transitory computer readable medium, including instructions which, if executed by one or more processors, cause the one or more processors to: determine, using first data representing an energy usage of a first vehicle, energy used by the first vehicle for propulsion; and estimate from the energy used by the first vehicle for propulsion a first air pressure, wherein the first air pressure is an air pressure at a first region, and wherein the first region is a region at a front of the first vehicle.

In Example 20, the non-transitory computer readable medium of Example 19, wherein the instructions are further configured to cause the processor to: estimate, using second data representing a vicinity of the first vehicle; a second air pressure at a second region, wherein the second region is different from the first region; and generate a signal when the second air pressure is less than the first air pressure.

In Example 21, the non-transitory computer readable medium of Example 19, wherein the instructions being configured to cause the processor to estimate the second air pressure includes the instructions being configured to cause the processor to use the second data to estimate an air pressure in the second region, wherein the second region is an area in a vicinity of a second vehicle, an obstacle, or a physical structure.

In Example 22, the non-transitory computer readable medium of Example 19 or 21, wherein the second sensor includes a camera or a Light Detection and Ranging (LiDAR) device, a Radio Detection and Ranging (RADAR) device, or a sensor to obtain map data.

In Example 23, the non-transitory computer readable medium of Example 22, wherein the instructions are further configured to cause the processor to determine a dimension or a velocity of the second vehicle, the obstacle, or the physical structure, and wherein the processor estimating the second air pressure includes the processor estimating the second air pressure using the dimension or the velocity.

In Example 24, the non-transitory computer readable medium of Example 22 or 23, wherein the second region is an area in a vicinity of the second vehicle, and wherein the instructions being configured to cause the processor to estimate the second air pressure includes the instructions being further configured to cause the processor to estimate the second air pressure based on a location of the second region relative to the second vehicle and based on a velocity or acceleration of the second vehicle.

In Example 25, the non-transitory computer readable medium of any one of Examples 19 to 24, further including a position sensor, configured to determine a position of the first vehicle or the second vehicle; and further including third data, corresponding to a map of a vicinity of the first vehicle or the second vehicle; and wherein the instructions are further configured to cause the processor to determine the second air pressure using the second data and the third data.

In Example 26, the non-transitory computer readable medium of any one of Examples 19 to 25, further including a position sensor, configured to determine a position of the first vehicle or the second vehicle; and further including fourth data, corresponding to weather of a vicinity of the first vehicle or the second vehicle; and wherein the instructions are configured to cause the processor to determine the first air pressure using the first data and the fourth data, or wherein the instructions are further configured to cause the processor to determine the second air pressure using the second data and the fourth data.

In Example 27, the non-transitory computer readable medium of any one of Examples 19 to 26, further including fifth data including one or more surface area dimensions of the second vehicle, and wherein the instructions are further configured to cause the processor to determine the first air pressure using the first data and the fifth data, or wherein the instructions are further configured to cause the processor to estimate the second air pressure using the second data and the fifth data.

In Example 28, the non-transitory computer readable medium of any one of Examples 19 to 27, further including sixth data including one or more drag coefficients of the first vehicle or the second vehicle, and wherein the instructions are further configured to cause the processor to determine the first air pressure using the first data and the sixth data, or wherein the instructions are further configured to cause the processor to estimate the second air pressure using the second data and the sixth data.

In Example 29, the non-transitory computer readable medium of any one of Examples 19 to 28, wherein the instructions are further configured to cause the processor to estimate an incline or decline of a road, and wherein the instructions are further configured to cause the processor to estimate the first air pressure or the second air pressure using the estimated incline or decline.

In Example 30, the non-transitory computer readable medium of any one of Examples 19 to 29, wherein the instructions are further configured to cause the processor to determine an ambient air temperature in a vicinity of the vehicle, and wherein the processor estimating the first air pressure or the second air pressure includes the processor estimating the first air pressure or the second air pressure using the ambient air temperature.

In Example 31, the non-transitory computer readable medium of any one of Examples 19 to 30, wherein the first data represent energy for vehicle propulsion as applied to one or more wheels of the first vehicle, and wherein the instructions are further configured to cause the processor to estimate the first air pressure based on the first data and at least one of a velocity or acceleration of the vehicle.

In Example 32, the non-transitory computer readable medium of any one of Examples 19 to 31, wherein the instructions are further configured to cause the processor to determine an area of increased danger in a vicinity of the second vehicle, and the instructions are further configured to cause the processor to define the second region such that the second region lacks the area of increased danger.

In Example 33, the non-transitory computer readable medium of any one of Examples 19 to 32, wherein the generating the signal includes the instructions being further configured to cause the processor to send an instruction or a recommendation to a driver assistance module or an autonomous driving module for the vehicle to travel to the second region.

In Example 34, the non-transitory computer readable medium of any one of Examples 19 to 33, wherein estimating the first air pressure includes estimating the first air pressure based on any of a power or force generated from an engine of the first vehicle, a change in elevation of the second vehicle, and a rolling resistance of the second vehicle.

In Example 35, the non-transitory computer readable medium of any one of Examples 19 to 34, further including an artificial neural network, wherein the instructions are further configured to cause the processor to estimate the first air pressure and the second air pressure using the artificial neural network.

In Example 36, a device, including: a first sensor for detecting first data representing an energy usage of a first vehicle; and a drag reduction determiner, for: determining, using the first data, energy used by the first vehicle for propulsion; estimating from the energy used by the first vehicle for propulsion a first air pressure, wherein the first air pressure is an air pressure at a first region, and wherein the first region is a region at a front of the first vehicle.

In Example 37, the device of Example 36, further including a second sensor for detecting second data representing a vicinity of the first vehicle; wherein the drag reduction determiner is further for: estimating, using the second data, a second air pressure at a second region, wherein the second region is different from the first region; and generating a signal when the second air pressure is less than the first air pressure.

In Example 38, the device of Example 36, wherein the drag reduction determiner being for estimating the second air pressure includes the drag reduction determiner being for using the second data to estimate an air pressure in the second region, wherein the second region is an area in a vicinity of a second vehicle, an obstacle, or a physical structure.

In Example 39, the device of Example 36 or 38, wherein the second sensor includes a camera or a Light Detection and Ranging (LiDAR) device, a Radio Detection and Ranging (RADAR) device, or a sensor to obtain map data.

In Example 40, the device of Example 39, wherein the drag reduction determiner is further for determining a dimension or a velocity of the second vehicle, the obstacle, or the physical structure, and wherein the drag reduction determiner estimating the second air pressure includes the drag reduction determiner estimating the second air pressure using the dimension or the velocity.

In Example 41, the device of Example 39 or 40, wherein the second region is an area in a vicinity of the second vehicle, and wherein the drag reduction determiner estimating the second air pressure includes the drag reduction determiner estimating the second air pressure based on a location of the second region relative to the second vehicle and based on a velocity or acceleration of the second vehicle.

In Example 42, the device of any one of Examples 36 to 41, further including a position sensor for determining a position of the first vehicle or the second vehicle; and further including third data, corresponding to a map of a vicinity of the first vehicle or the second vehicle; and wherein the drag reduction determiner is further for determining the second air pressure using the second data and the third data.

In Example 43, the device of any one of Examples 36 to 42, further including a position sensor for determining a position of the first vehicle or the second vehicle; and further including fourth data, corresponding to weather of a vicinity of the first vehicle or the second vehicle; and wherein the drag reduction determiner is further for determining the first air pressure using the first data and the fourth data, or wherein the drag reduction determiner is further for determining the second air pressure using the second data and the fourth data.

In Example 44, the device of any one of Examples 36 to 43, further including fifth data including one or more surface area dimensions of the second vehicle, and wherein the drag reduction determiner is further configured to determine the first air pressure using the first data and the fifth data, or wherein the drag reduction determiner is further configured to estimate the second air pressure using the second data and the fifth data.

In Example 45, the device of any one of Examples 36 to 44, further including sixth data including one or more drag coefficients of the first vehicle or the second vehicle, and wherein the drag reduction determiner is further for determining the first air pressure using the first data and the sixth data, or wherein the drag reduction determiner is further for estimating the second air pressure using the second data and the sixth data.

In Example 46, the device of any one of Examples 36 to 45, wherein the drag reduction determiner is further for estimating an incline or decline of a road, and wherein the drag reduction determiner is further for estimating the first air pressure or the second air pressure using the estimated incline or decline.

In Example 47, the device of any one of Examples 36 to 46, wherein the drag reduction determiner is further for determining an ambient air temperature in a vicinity of the vehicle, and wherein the drag reduction determiner being for estimating the first air pressure or the second air pressure includes the drag reduction determiner being for estimating the first air pressure or the second air pressure using the ambient air temperature.

In Example 48, the device of any one of Examples 36 to 47, wherein the first data represent energy for vehicle propulsion as applied to one or more wheels of the first vehicle, and wherein the drag reduction determiner is configured to estimate the first air pressure based on the first data and at least one of a velocity or acceleration of the vehicle.

In Example 49, the device of any one of Examples 36 to 48, wherein the drag reduction determiner is further for determining an area of increased danger in a vicinity of the second vehicle, and the drag reduction determiner further for defining the second region such that the second region lacks the area of increased danger.

In Example 50, the device of any one of Examples 36 to 49, wherein the vehicle being for generating the signal includes the vehicle being for sending an instruction or a recommendation to a driver assistance module or an autonomous driving module for the vehicle to travel to the second region.

In Example 51, the device of any one of Examples 36 to 50, wherein the device is configured as a component of the vehicle, of a component of an autonomous driving system of the vehicle, or a component of a driver assist system of the vehicle.

In Example 52, the device of any one of Examples 36 to 51, wherein estimating the first air pressure includes estimating the first air pressure based on any of a power or force generated from an engine of the first vehicle, a change in elevation of the second vehicle, and a rolling resistance of the second vehicle.

In Example 53, the device of any one of Examples 36 to 52, further including an artificial neural network, wherein the drag reduction determiner is configured to estimate the first air pressure and the second air pressure using the artificial neural network.

In Example 54, a method of reducing drag, including: detecting first data representing an energy usage of a first vehicle; determining, using the first data, energy used by the first vehicle for propulsion; and estimating from the energy used by the first vehicle for propulsion a first air pressure, wherein the first air pressure is an air pressure at a first region, and wherein the first region is a region at a front of the first vehicle.

In Example 55, the method of reducing drag of Example 54, further including: detecting second data representing a vicinity of the first vehicle; estimating, using the second data, a second air pressure at a second region, wherein the second region is different from the first region; and generating a signal when the second air pressure is less than the first air pressure.

In Example 56, the method of reducing drag of Example 54, wherein the estimating the second air pressure includes the using the second data to estimate an air pressure in the second region, wherein the second region is an area in a vicinity of a second vehicle, an obstacle, or a physical structure.

In Example 57, the method of reducing drag of Example 54 or 56, wherein the second data is estimated from a camera or a Light Detection and Ranging (LiDAR) device, a Radio Detection and Ranging (RADAR) device, or a sensor to obtain map data.

In Example 58, the method of reducing drag of Example 57, further including determining a dimension or a velocity of the second vehicle, the obstacle, or the physical structure, and wherein the estimating the second air pressure includes estimating the second air pressure using the dimension or the velocity.

In Example 59, the method of reducing drag of Example 57 or 58, wherein the second region is an area in a vicinity of the second vehicle, and wherein the estimating the second air pressure includes the estimating the second air pressure based on a location of the second region relative to the second vehicle and based on a velocity or acceleration of the second vehicle.

In Example 60, the method of reducing drag of any one of Examples 54 to 59, further including determining a position of the first vehicle or the second vehicle; and further including third data, corresponding to a map of a vicinity of the first vehicle or the second vehicle; and further including determining the second air pressure using the second data and the third data.

In Example 61, the method of reducing drag of any one of Examples 54 to 60, further including determining a position of the first vehicle or the second vehicle; and further including fourth data, corresponding to weather of a vicinity of the first vehicle or the second vehicle; and further including determining the first air pressure using the first data and the fourth data, or wherein the processor is further configured to determine the second air pressure using the second data and the fourth data.

In Example 62, the method of reducing drag of any one of Examples 54 to 61, further including fifth data including one or more surface area dimensions of the second vehicle, and further including determining the first air pressure using the first data and the fifth data, or wherein estimating the second air pressure using the second data and the fifth data.

In Example 63, the method of reducing drag of any one of Examples 54 to 62, further including sixth data including one or more drag coefficients of the first vehicle or the second vehicle, and further including determining the first air pressure using the first data and the sixth data, or estimating the second air pressure using the second data and the sixth data.

In Example 64, the method of reducing drag of any one of Examples 54 to 63, further including estimating an incline or decline of a road, and further including estimating the first air pressure or the second air pressure using the estimated incline or decline.

In Example 65, the method of reducing drag of any one of Examples 54 to 64, further including determining an ambient air temperature in a vicinity of the vehicle, and wherein the estimating the first air pressure or the second air pressure includes estimating the first air pressure or the second air pressure using the ambient air temperature.

In Example 66, the method of reducing drag of any one of Examples 54 to 65, wherein the first data represent energy for vehicle propulsion as applied to one or more wheels of the first vehicle, and further including estimating the first air pressure based on the first data and at least one of a velocity or acceleration of the vehicle.

In Example 67, the method of reducing drag of any one of Examples 54 to 66, further including determining an area of increased danger in a vicinity of the second vehicle, and defining the second region such that the second region lacks the area of increased danger.

In Example 68, the method of reducing drag of any one of Examples 54 to 67, wherein the generating the signal includes the sending an instruction or a recommendation to a driver assistance module or an autonomous driving module for the vehicle to travel to the second region.

In Example 69, the method of reducing drag of any one of Examples 54 to 68, wherein estimating the first air pressure includes estimating the first air pressure based on any of a power or force generated from an engine of the first vehicle, a change in elevation of the second vehicle, and a rolling resistance of the second vehicle.

In Example 70, the method of reducing drag of any one of Examples 54 to 69, further including an artificial neural network, and estimating the first air pressure and the second air pressure using the artificial neural network.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all Examples included herein.

What is claimed is:

1. A device, comprising:
a first sensor, configured to detect first data representing an energy usage of a first vehicle; and
a processor, configured to:
determine, using the first data, energy used by the first vehicle for propulsion; and
estimate, from the energy used by the first vehicle for propulsion, a first air pressure, wherein the first air pressure is an air pressure at a first region, and wherein the first region is a region at a front of the first vehicle.

2. The device of claim 1, further comprising a second sensor, configured to detect second data representing a vicinity of the first vehicle;
wherein the processor is further configured to:
estimate, using the second data, a second air pressure at a second region, wherein the second region is different from the first region; and
generate a signal when the second air pressure is less than the first air pressure.

3. The device of claim 2, wherein the processor estimating the second air pressure comprises the processor using the second data to estimate an air pressure in the second region, wherein the second region is an area in a vicinity of a second vehicle, an obstacle, or a physical structure.

4. The device of claim 3, wherein the second sensor comprises a camera or a Light Detection and Ranging (LiDAR) device, a Radio Detection and Ranging (RADAR) device, or a sensor to obtain map data.

5. The device of claim 4, wherein the processor is further configured to determine a dimension or a velocity of the second vehicle, the obstacle, or the physical structure, and wherein the processor estimating the second air pressure comprises the processor estimating the second air pressure using the dimension or the velocity.

6. The device of claim 4, wherein the second region is an area in a vicinity of the second vehicle, and wherein the processor estimating the second air pressure comprises the processor estimating the second air pressure based on a location of the second region relative to the second vehicle and based on a velocity or acceleration of the second vehicle.

7. The device of claim 3, further comprising a position sensor, configured to determine a position of the first vehicle or the second vehicle; and further comprising third data, corresponding to a map of a vicinity of the first vehicle or the second vehicle; and wherein the processor is further configured to determine the second air pressure using the second data and the third data.

8. The device of claim 3, further comprising a position sensor, configured to determine a position of the first vehicle or the second vehicle; and further comprising fourth data, corresponding to weather of a vicinity of the first vehicle or the second vehicle; and wherein the processor is further configured to determine the first air pressure using the first data and the fourth data, or wherein the processor is further configured to determine the second air pressure using the second data and the fourth data.

9. The device of claim 3, further comprising fifth data comprising one or more surface area dimensions of the second vehicle, and wherein the processor is further configured to determine the first air pressure using the first data and the fifth data, or wherein the processor is further configured to estimate the second air pressure using the second data and the fifth data.

10. The device of claim 3, further comprising sixth data comprising one or more drag coefficients of the first vehicle or the second vehicle, and wherein the processor is further configured to determine the first air pressure using the first data and the sixth data, or wherein the processor is further configured to estimate the second air pressure using the second data and the sixth data.

11. The device of claim 2, wherein the processor is further configured to estimate an incline or decline of a road, and wherein the processor is further configured to estimate the first air pressure or the second air pressure using the estimated incline or decline.

12. The device of claim 2, wherein the processor is further configured to determine an ambient air temperature in a vicinity of the first vehicle, and wherein the processor estimating the first air pressure or the second air pressure comprises the processor estimating the first air pressure or the second air pressure using the ambient air temperature.

13. The device of claim 1, wherein the first data represent energy for vehicle propulsion as applied to one or more wheels of the first vehicle, and wherein the processor is configured to estimate the first air pressure based on the first data and at least one of a velocity or acceleration of the first vehicle.

14. The device of claim 3, wherein the processor is further configured to determine a plurality of candidate second regions and an area of increased danger in a vicinity of the second vehicle, and wherein the processor is configured to define the second region as a second region of the plurality of candidate second regions outside of the area of increased danger.

15. The device of claim 2, wherein the first vehicle generating the signal comprises the first vehicle sending an instruction or a recommendation to a driver assistance module or an autonomous driving module for the first vehicle to travel to the second region.

16. The device of claim 1, wherein the device is configured as a component of the first vehicle, of a component of an autonomous driving system of the first vehicle, or a component of a driver assist system of the first vehicle.

17. The device of claim 3, wherein estimating the first air pressure comprises estimating the first air pressure based on any of a power or force generated from an engine of the first vehicle, a change in elevation of the second vehicle, and a rolling resistance of the second vehicle.

18. The device of claim 2, further comprising an artificial neural network, wherein the processor is configured to estimate the first air pressure and the second air pressure using the artificial neural network.

19. A non-transitory computer readable medium, comprising instructions which, if executed by a processor, cause one or more processors to:
determine, using first data representing an energy usage of a first vehicle, energy used by the first vehicle for propulsion; and
estimate from the energy used by the first vehicle for propulsion a first air pressure, wherein the first air pressure is an air pressure at a first region, and wherein the first region is a region at a front of the first vehicle.

20. The non-transitory computer readable medium of claim 19, wherein the instructions are further configured to cause the processor to:
estimate, using second data representing a vicinity of the first vehicle; a second air pressure at a second region, wherein the second region is different from the first region; and
generate a signal when the second air pressure is less than the first air pressure.
